(19) United States
(12) Patent Application Publication
(10) Pub. No.: US 2012/0268008 A1
(43) Pub. Date: Oct. 25, 2012

(54) LED Circuits and Assemblies

(75) Inventors: Michael Miskin, Sleepy Hollow, IL (US); Robert L. Kottritsch, Shefford (GB)

(73) Assignee: LYNK LABS, INC., Elgin, IL (US)

(21) Appl. No.: 13/502,796

(22) PCT Filed: Oct. 19, 2010
(86) PCT No.: PCT/US2010/002780

§ 371 Date: Jul. 5, 2012

Related U.S. Application Data
(60) Provisional application No. 61/252,920, filed on Oct. 19, 2009.

(30) Foreign Application Priority Data
Apr. 30, 2010 (US) PCT/US2010/001269

(51) Int. Cl. H05B 37/02; H01R 43/00; H05B 37/00

(52) U.S. Cl. 315/86; 315/192; 29/825

(57) ABSTRACT

An AC-driven LED circuit 10 includes a first basic circuit 12 having a first branch 14 and a second branch 16 which connect at first and second common points 18, 20 wherein the common points 18, 20 provide input and output for an AC driving current. Each circuit branch includes two LEDs 26, 28 or 30, 32 connected in opposing series relationship such that either the output or input of each LED in the branch join at branch junctions 34, 36. Improvement in performance and scalability is provided by adding n diodes to a given basic circuit and x cross connecting circuit branch diodes (40, 44) and providing one or more basic circuits (15) in series and or parallel. The basic circuits can be packaged and incorporated into AC LED lighting elements capable of integration with lighting devices or systems.

### RELATED APPLICATIONS

The application is a continuation-in-past of International Application No. PCT/US2010/001269 filed Apr. 30, 2010, which claims priority to U.S. Provisional Application No. 61/215,144 filed May 1, 2009 and is a continuation-in-part of U.S. patent application Ser. No. 12/287,267, filed Oct. 6, 2008, which claims the priority to U.S. Provisional Application No. 60/997,771, filed Oct. 6, 2007; this application also claims priority to U.S. Provisional Application No. 61/252,920, filed Oct. 19, 2009; the contents of each of these applications are expressly incorporated herein by reference.

### FIELD OF THE INVENTION

The present invention relates generally to light-emitting diode (“LED”) circuits and assemblies; and more specifically to scalable alternating current (“AC”) driven LED circuits and assemblies and implementing the same into lighting devices.

### SUMMARY OF THE INVENTION

While not intending to limit the scope of the claims or disclosure, in brief summary, the present disclosure and claims are directed to providing improved ease of designing and building LED lighting devices, LED lamps and lighting fixtures using AC-driven LEDs. Disclosed herein are LED circuits having scalable circuit configurations and LED light element/package assembly configurations which can be used in an AC-drive platform to more easily match the voltage requirements of the lighting fixture(s) or systems in which the LED's are desired. Circuits and LED light elements and package assemblies are disclosed which provide a scalable voltage matching design platform, reduce objectionable flicker produced from AC-driven LEDs, reduce power supply cost or eliminate the need to change the power supply needed to power the LEDs. LED packages and light elements are provided for lighting design according to the invention which address flicker at low frequencies (e.g. 50/60 Hz) while being scalable as desired for a particular lighting goal. Circuits are disclosed herein which provide for some of the LEDs in a circuit to be on during both positive and negative phases of an AC source, to among other things, address flicker. Also, circuits are disclosed wherein a basic circuit design provides a voltage and current performance whereby scalability or matching a particular voltage requirement is achieved by configuring LEDs in the basic design and/or by joining one or more of the basic circuits together in series or parallel to achieve the design requirement.

According to an embodiment of the invention an AC-driven LED circuit is proposed having at least a first basic circuit comprising LEDs. Each LED has an input and an output, the circuit having at least first and second branches connecting at first and second common points, the common points providing input and output for an AC driving current for the circuit. This circuit as well as others described herein incorporate various numbers of LEDs may be referred to herein as a “circuit module,” a “basic LED circuit,” or a “subcircuit,” given the fact that according to an aspect of the invention, such circuits themselves may be joined with other such circuits in either parallel, series or series-parallel relationship to each other. The first branch of the basic LED circuit has a first and a second LED, and the second branch has a third and a fourth LED. The first LED is connected to the second LED in opposing series relationship with the inputs of the first and second LEDs defining a first branch junction. The third LED is connected to the fourth LED in opposing series with the outputs of the third and fourth LEDs defining a second branch junction. The first and second branches are connected to one another such that the output of the first LED is connected to the input of the third LED at the first common point and the output of the second LED is connected to the input of the fourth LED at the second common point. At least one (or a first) cross-connecting circuit branch having at least a fifth LED is provided in an embodiment of the invention, the first cross-connecting circuit being configured such that the input of the fifth LED is connected to second branch junction and its output is connected to the first branch junction. It is important to note that according to an embodiment and aspect of the invention, the circuits disclosed herein, result in an opposing parallel relationship of certain LEDs and further resulting in an imbalanced bridge effect in operation.

An AC LED bridge is an LED topology where the self rectifying property of opposing parallel. LED strings are used to drive a set of ‘bridge’ LEDs with rectified current. An imbalanced bridge is the general implementation of this topology where one side of the input to the bridge has a different number of LEDs in series than the other side. A balanced bridge is a particular implementation of this topology where the input and output sides have equal numbers of LEDs in series. When used in a specific voltage drive regime, such as 12 VAC, the advantage of an imbalanced bridge topology is that it can be constructed for example with standard GaN die so that the forward combined voltage of the die in one phase cycle is closely matched to the native supply voltage while the reverse voltage applied to the diodes in the opposing phase is kept to an acceptable level blow the reverse breakdown voltage of the die.

According to another embodiment of the invention, an AC-driven LED circuit having a basic opposing parallel configuration is provided. Each opposing parallel LED circuit contains a first branch and second branch, wherein the first and second branches connect at a first common point and a second common point. The common points provide an input and output for an AC-driven current. The first branch of the opposing parallel LED circuit has n number of LEDs connected in series while the second branch of the opposing parallel LED circuit has n number of LEDs connected in series. The LEDs in the first branch are connected in a manner wherein the input for each LED is orientated towards the first common point while the outputs are orientated towards the second common point. The LEDs in the second branch are connected in a manner wherein the output for each LED is orientated towards the first common point while the inputs for each LED is orientated towards the second common point.

According to another embodiment of the invention, an AC-driven LED circuit may comprise one or more additional basic circuits each being the same as the first basic circuit identified above. Each additional circuit being conductively connected to the first basic circuit and to one another at the common points for providing an input and an output for an AC driving current of the circuit. According to other embodiments, the additional basic circuits may be connected in series to the first basic circuit and to one another, or the additional basic circuits may be connected in parallel to the first basic circuit and to one another, or additional circuits may be connected in series-parallel. It should be appreciated by those having skill in the art that additional opposing parallel circuits can be conductively connected to a first opposing parallel circuit as described above. It should be further appreciated by those having skill in the art that a combination of basic circuits as described above and opposing parallel circuits can be connected in either series, parallel or series parallel to arrive at a desired light level or current and/or to match a total voltage drop with the voltage produced at a voltage source connected to the circuit(s).

According to another embodiment of the invention, n additional LEDs, in pairs, may be provided in the circuit wherein the pairs are configured among the first and second branch circuits of each of the respective basic circuits or modules, such that current flows through the respective fifth diode of each basic circuit upon both a negative and positive phase of the AC driving source, and so that the current draw through each of the respective basic circuits during both AC phases is substantially the same.

According to another embodiment the AC-driven LED circuit further comprises x cross-connecting circuit branches each having one or more LEDs and being configured such that current flows through each of the respective one or more LEDS upon both a negative and positive phase of the AC driving source, and so that the current draw through each of the respective basic circuits during both AC phases is substantially the same.

According to another embodiment and aspect of the invention, the opposing parallel LED circuit, the basic LED circuit, and more complex circuits derived there from include one or more of a resistor, a transient or surge protector, and a fuse; in any number or combination respecting the needed or desired impedance, resistance, drive current/voltage protection, and/or to match the voltage drop across the load with the voltage produced by the source to substantially maximize the efficiency of the circuit.

According to another aspect and embodiment of the invention, the circuit embodiments described herein are formed on a single semiconductor chip. Another embodiment and aspect of the invention provides that the circuits described and claimed herein are formed by wiring individual LED die together on a substrate.

According to another embodiment of the invention, an AC-driven LED assembly comprises at least a first and a second LED each discretely packaged, the LEDs being connected in an AC circuit and each LED package being mounted to a substrate at a distance from the other of preferably approximately 3 mm or less, and more preferably 2.0 mm or less. In an embodiment the packaged LEDs also each have a length of preferably approximately 2.5 mm or less, and more preferably 2.0 mm or less. In an embodiment the packaged LEDs also each have a width of preferably approximately 2.5 mm or less, and more preferably 2.0 mm or less. In an embodiment the LED packages are arranged with respect to each other in a linear spatial relationship while in another embodiment the LED packages are arranged with respect to each other in an XY rectilinear spatial relationship.

According to another embodiment of the present invention, one or more basic LED circuits, one or more opposing parallel LED circuits, or a combination thereof are packaged and integrated into an AC LED lighting element having a conventional or non-legacy or conventional lamp base, capable of being utilized in lighting fixtures or systems, like for example, lamps, track lighting, etc. The AC LED lighting element may include known conventional lamp bases including but not limited to: Edison base (E-base); bi-pin; wedge base; or any other lamp bases similar to those used in incandescent, fluorescent, xenon, halogen or other existing lamp types. It should be appreciated by those having skill in the art that the AC LED lighting element may include non-conventional or custom lamp bases designed for specific lighting applications. In an alternative embodiment, it is contemplated that the base may include a dielectric portion having at least two separate conductive points electrically connected to the basic circuit on a first side and configured on a second side for connecting the basic circuit with a lighting fixture or system.

It should be further appreciated by those having ordinary skill in the art that both the basic and opposing parallel LED circuits can be packaged for use in any lighting device or system capable of having a replaceable lighting element or can be directly incorporated into OEM lighting systems or devices utilizing conventional or non-conventional lamp bases.

According to another embodiment of the present invention, the basic and/or opposing parallel circuits are configured to have a total known voltage drop within the tolerances of any LEDs or other circuit components used therein. Utilizing known voltage drops in each LED circuit allows, for example, enhanced scalability of AC LED lighting elements in lighting devices and systems in order to account for different source voltages. Such scalability likewise allows for maximum efficiency when using a source voltage. For example, each LED circuit within in a given AC LED lighting element may consist of LEDs which have a total voltage drop of 12 VAC in both the positive and negative direction. Such a lighting element could be packaged to include five LED circuits in series in order to operate off a voltage source supplying 60 VAC, or may instead be packaged with 20 LED circuits in series to operate off of a voltage source supplying 240 VAC.

Utilizing substantially identical LED circuits within each lighting element further allows for an AC LED lighting element to be moved from one source to another. For example, a LED lighting element being used with a 60 VAC source having five 12 VAC LED circuits may be modified and to include 15 additional 12 VAC LED circuits added for use with a 240 VAC source. Such a system eliminates the necessity to purchase different lighting elements for lighting devices or systems utilizing different voltage sources. Rather, all that is necessary is to modify the AC LED lighting element in order to insure that the total voltage drop across all of the AC LED circuits in the AC LED lighting element match the voltage provided at the source, is the addition or subtraction of additional AC LED circuits or other common circuit components which act to consume voltage.

As should be appreciated by those having skill in the art, the voltage drop of each LED within the LED circuit determines the number of LEDs in the circuit. For example, for a 12 VAC LED circuit utilizing LEDs having a 2.2 VAC drop across each LED, five LEDs and perhaps an additional circuit component, like for example a resistor, may be incorporated in both the forward and backwards direction. As should be appreciated by those having skill in the art, in order to increase the total voltage drop across a given basic circuit, n additional LEDs can be added in pairs to the first and second branch of the basic circuit. It is contemplated that any number of LEDs can be added to a single basic circuit in order to achieve a total desired voltage drop across the entirety of the circuit. Such a design feature provides the advantage of utilizing a single circuit to match any voltage source wherein only the total number of LEDs within the circuit changes, and enhances the scalability of the LED lighting elements.

According to another embodiment of the present invention, the LED circuits and/or the LED lighting elements are capable of incorporating additional circuit components in order to match a source voltage and/or achieve a desired light output level. If a lower light output than that produced by five 12 VAC LED circuits powered by a 60 VAC source, the LED lighting element of the present invention is capable of being scaled with three 12 VAC LED circuits and an additional circuit component, like for example a resistor, in order to match the 60 VAC source.

According to another embodiment of the present invention, an AC LED lighting element may be incorporated into lighting systems or devices which utilize both AC voltage sources as well as DC backup supply in emergency situations. In order to maximize the efficiency of the AC LED lighting element, it is contemplated that any DC back up supply, for example a battery or capacitor, provide a voltage substantially equivalent to the AC voltage provided to the AC LED lighting element. In the alternative, it is contemplated that an additional circuit, for example a resistive circuit, can be placed between the DC back up supply and the AC LED lighting element so as to allow the additional circuit and the AC LED lighting element to match the voltage produced by the back up supply.

According to another embodiment of the present invention, a DC backup supply matching the total forward voltage of all basic and/or opposing parallel circuits within the AC LED lighting element may be provided and included within the AC LED lighting element to activate at least one LED or one branch of each basic and/or opposing parallel circuit to provide lighting in emergency situations.

According to another embodiment of the present invention a basic circuit and a DC backup supply, like for example a battery or capacitor, may be integrated into an AC LED light element or AC LED light fixture. The DC backup supply may be controlled using any means known in the art, and may be configured to provide power to one or more of the LEDs in the basic circuit. For example, the DC backup source may be controlled using an optical light sensor or a remote control operated by a user. As should be appreciated by those having skill in the art, the DC backup supply is capable of providing power to a single LED or to either the first or second branch of the basic circuit.

### BRIEF DESCRIPTION OF THE DRAWINGS

FIG. 1 is a schematic view of a basic AC-driven LED circuit according to an embodiment of the invention;

FIG. 2 is a schematic view of a basic AC-driven LED circuit according to an embodiment of the invention;

FIG. 3 is a schematic view of a basic AC-driven LED circuit according to an embodiment of the invention;

FIG. 4 is a schematic view of a basic AC-driven LED circuit according to an embodiment of the invention;

FIG. 5 is a schematic view of a basic AC-driven LED circuit according to an embodiment of the invention;

FIG. 6 is a schematic top view of an AC-driven LED assembly according to an embodiment of the invention;

FIG. 7 is a schematic top view of an AC-driven LED assembly according to an embodiment of the invention;

FIG. 8 is a schematic side view of an AC-driven LED assembly according to an embodiment of the invention;

FIG. 9 is a schematic view of a modification to the basic AC-driven circuit 70 of FIG. 4;

FIG. 10 is a schematic view of an AC-driven LED circuit according to an embodiment of the invention;

FIG. 11 is an embodiment of an AC-driven LED light element as contemplated by the invention.

FIG. 12 is an embodiment of an AC-driven LED light element as contemplated by the invention;

FIG. 13 is an embodiment of an AC-driven LED light element as contemplated by the invention;

FIG. 14 is a prior art wedge base type light; and,

FIG. 15 is an embodiment of an AC-driven LED light element as contemplated by the invention.

FIG. 16 is a diagram of an AC-driven LED light element according to an embodiment of the invention.

### DETAILED DESCRIPTION OF THE PRESENT INVENTION

While this invention is susceptible to embodiments in many different forms, there are shown in the drawings and will herein be described in detail, preferred embodiments of the invention with the understanding that the present disclosures are to be considered as exemplifications of the principles of the invention and are not intended to limit the broad aspects of the invention to the embodiments illustrated. Like components in the various FIGS. will be given like reference numbers.

FIG. 1 discloses an AC-driven LED circuit 10 including a first basic circuit 12 having a first branch 14, and a second branch 16. Branches 14, 16 connect at first common point 18 and second common point 20. The common points 18, 20 provide input and output for an AC driving current from a driver 24 for the circuit.

The first branch 14 has a first LED 26 and a second LED 28, and the second branch 16 having a third LED 30 and a fourth LED 32. The first LED 26 is connected to the second LED 28 in opposing series relationship with the inputs of the first and second LEDs 26, 28 defining a first branch junction 34. The third LED 30 is connected to the fourth LED 32 in opposing series with the outputs of the third and fourth LEDs 30, 32 defining a second branch junction 36.

The first and second branches 34, 36 are connected to one another such that the output of the first LED 26 is connected to the input of the third LED 30 at the first common point 18 and the output of the second LED 28 is connected to the input of the fourth LED 32 at the second common point 20, A first cross-connecting circuit branch 38 has a fifth LED 40. The first cross-connecting circuit branch 38 being configured such that the input of the fifth LED 40 is connected to second branch junction 36 and the output is connected to the first branch junction 34.

As will be appreciated by those of skill in the art, the LED's 26 and 32 will provide light only upon one half of an AC wave, pulse or phase, while LEDs 28 and 30 will provide light only upon the opposite wave, pulse or phase. At lower frequencies, e.g. mains frequencies, if the LEDs are spaced pursuant to another aspect of the invention (disclosed below) at preferably approximately 3.0 mm or less preferably approximately 2.0 mm or less, then the amount of noticeable flicker may not be unacceptable. However, the cross connecting circuit 38 and diode 40 will be on (produce light) in both phases of the AC drive and hence mitigate flicker which may be evidenced in its surrounding LEDs 26, 28, 30 and 32.

Advantageously the LED circuit 10 provides an LED topology an imbalanced bridge effect as one side of the circuit has a different number of LEDs in series than the other side. This characteristic is also disclosed in all of the circuits in FIGS. 1-9.

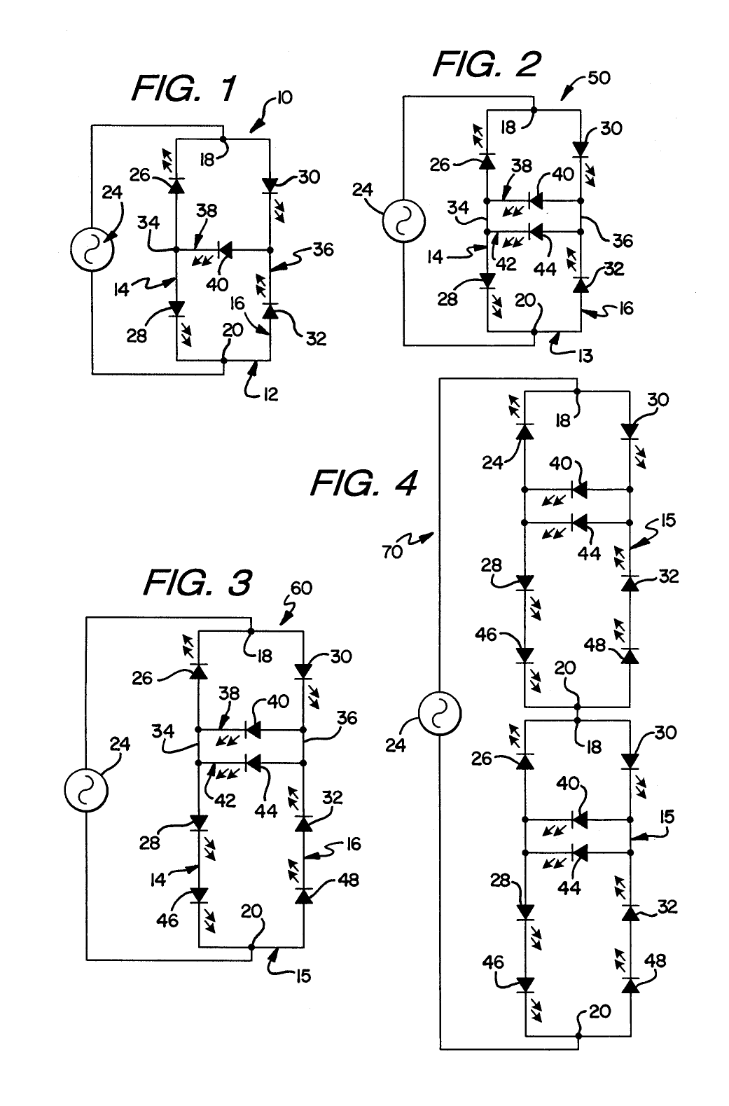

FIG. 2 discloses an AC-driven LED circuit 50 which is a modification of AC-driven LED circuit 10. Circuit 50 further mitigates flicker. Circuit 50 provides an additional cross-connecting circuit branch 42 having LED 44. The LEDS 40, 44 are configured such that current flows through each upon both a negative and positive phase of the AC driving source 24. It should be appreciated that according to the invention x number of such cross connecting circuit branches (such as 38, 42) may be added as desired, however, since the LEDs (such as LEDs 40, 44) are in parallel with each other, their voltage demand will be divided while their current draw will not. Hence a suitable driver need be provided for this circumstance.

To increase the light output of the circuit of the invention, it should be noted as disclosed in FIG. 3 that additional or n LEDS may be provided in the branches 14 and 16. Specifically FIG. 3 discloses an AC-driven circuit 60 which is a modification of circuit 50. Circuit 60 provides for additional LEDs 46 and 48. The pair of LEDs are configured among the first and second branch circuits 14, 16 of the basic circuit 15 such that current flows through the respective diodes 40, 44 upon both a negative and positive phase of the AC driving source 24 and so that the current draw through basic circuit 15 during both AC phases is substantially the same.

It should be noted that according to the invention, n pairs of LEDs can be configured among first and second branch circuits of a respective basic circuit, such that current flows through the respective cross connecting circuit branch LEDs of a basic circuit upon both a negative and positive phase of the AC driving source and so that the current draw through each of the respective basic circuits during both AC phases is substantially the same. More LEDs in the branch circuits divide the current from the higher current LEDs in cross connecting circuits 38, 42.

According to another aspect of the invention, to further mitigate the amount of flicker perceived, adding to the light provided and to scalability, additional basic circuits, each being the same as the first basic circuit, may be conductively connected to the first basic circuit in series or parallel at the their common points 18, 20 for providing an input and an output for an AC driving current for the circuit.

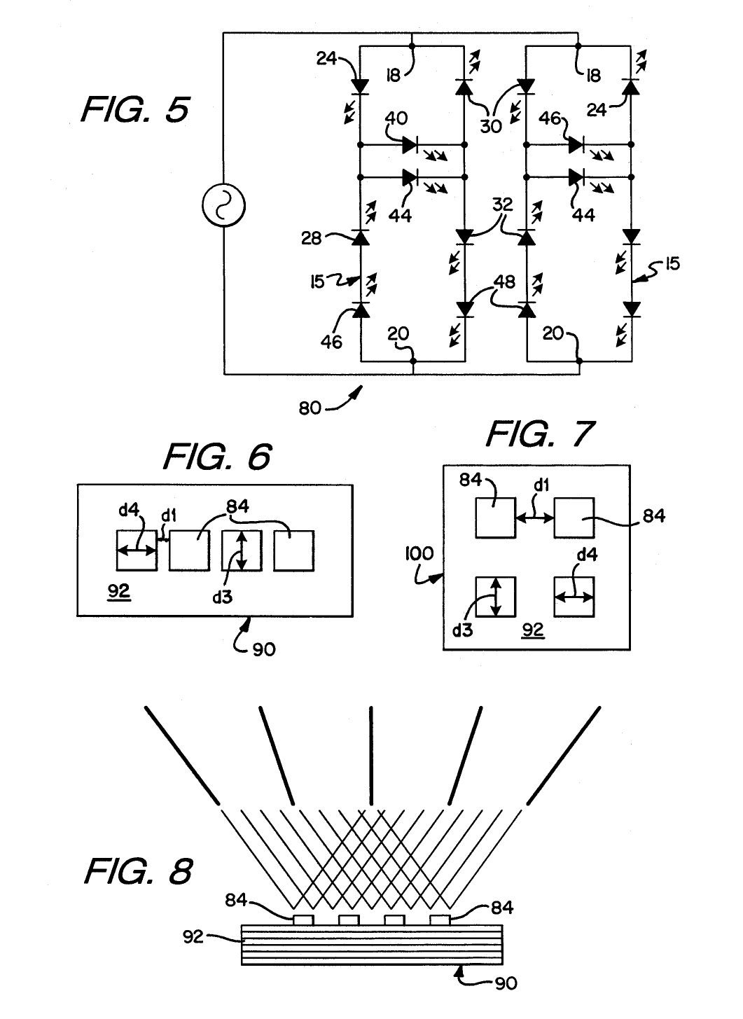

For instance, FIG. 4 discloses an AC-driven LED circuit 70 which includes additional basic circuits 15 connected in series at common points 18, 20. Additionally, as seen in FIG. 5, an AC-driven LED circuit 80 includes additional basic circuits 15 connected in parallel at common points 18, 20. This embodiment shows the utility of providing a scalable circuit that can be manufactured modularly and used to connect to match higher voltage requirements, for e.g., circuit 15 may draw 12 VAC while two such circuits 15 in series would draw 24 VAC requirements, three such circuits would draw 36 VAC, etc. It is contemplated by the invention that any number of additional basic circuits can be added in series or parallel as shown in FIGS. 4 and 5 respectively so as to match a total voltage provided by a given voltage source.

Preferably, the number and type of LEDs in the AC-driven LED circuit draws a combined current and combined voltage which is substantially equal to the nominal voltage capacity of the AC drive source. Alternatively, it, is contemplated by the present invention that the combined current and voltage drawn by a combination of multiple AC-driven LED circuits connected together in either series or parallel are substantially equal to the nominal voltage capacity of the AC drive source.

As shown in FIG. 6, an AC-driven LED assembly 90 has a first and a second LED 84 each discretely packaged, the LEDs being connected in an AC circuit and each LED package 84 being mo ted to a substrate 92 at a distance dl from the other of preferably approximately 3 min or less, and more preferably 2.0 mm or less. The AC-driven LED assembly 90 also has packaged LEDs 84 each having a width d4 and a length d3 of preferably approximately 2.5 mm or less, and more preferably 2.0 mm or less.

FIG. 6 discloses an AC-driven LED assembly 90 wherein the LED packages 84 are arranged with respect to each other in a linear spatial relationship, while FIG. 7 discloses an assembly 100 wherein the LED packages 84 are arranged with respect to each other in an XY rectilinear spatial relationship.

As can be seen in FIG. 8, when LED packages 84 are placed at 3 mm or less, the light produced therefrom intersects, thereby reducing or eliminating the effects of flicker.

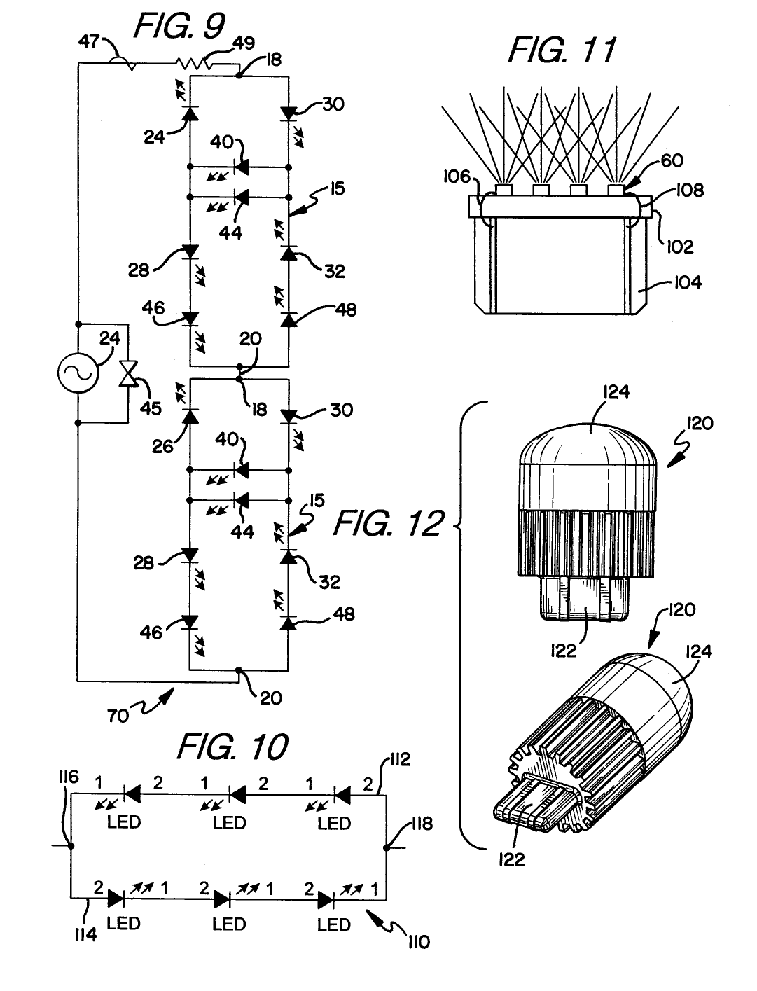

FIG. 9 discloses a modification to AC-driven circuit 70 which according to the invention, whether embodied on a single chip, or to other another substrate or circuit board mounting, is provided with one or more at the option of the design criteria, to include one or more of a transient voltage suppressor 45 or like device, a fuse 47, or like device (for e.g,. a PTC device) and a resistor 49. The resistor 49 may be unnecessary in a design where the resistance/impedance of the fusing and/or overvoltage devices are sufficient for the circuit performance.

FIG. 10 discloses an opposing parallel AC-driven LED circuit 110 which is capable for use in place of or in conjunction with any of the first basic circuits disclosed in FIGS. 1-5 and 9. Circuit 110 includes a first branch 112 and a second branch 114 being connected at common points 116 and 118. The common points 116, 118 provide input and output for an AC driving current from a driver (not pictured) for the circuit. Each branch 112, 114 includes an identical number of LEDs, n. In embodiments utilizing both a basic circuit, like for example circuit 10 in FIG. 1, it is contemplated that opposing parallel circuit 110 can be connected at common points 18, 20, 116, and/or 118 in either series or parallel.

FIG. 11 discloses an embodiment wherein LED circuit 60 as contemplated in FIG. 3 is mounted on a dielectric substrate 102. Dielectric substrate 102 is configured such that LED circuit is mounted on a first side and a conventional or non-conventional base 104 for connecting to a light fixture is formed on a second side, shown in FIG. 11 as a wedge base. The dielectric substrate 102 further includes connection points 106 and 108 on the first side for providing power to LED circuit 60 from the conventional or non-conventional base 104.

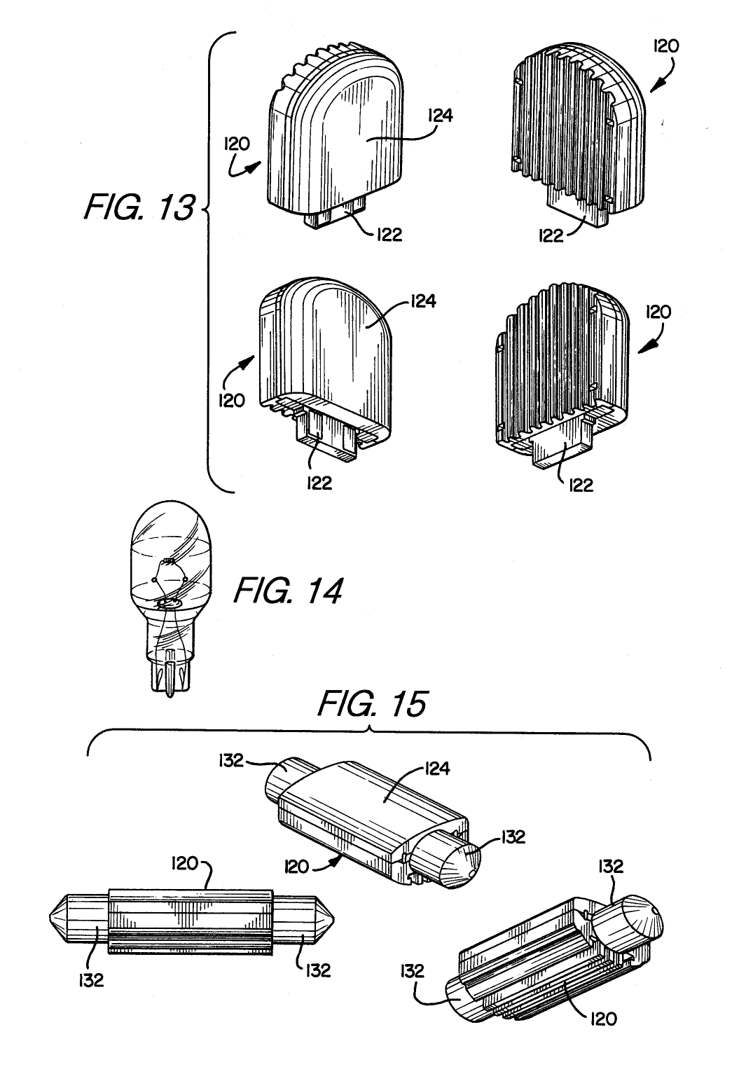

FIGS. 12 and 13 disclose an AC-driven LED lighting element 120 integrating the basic circuit, like that shown as circuit 10 in FIG. 1 or circuit 50 in FIG. 2, and/or an opposing parallel LED circuit, like circuit 110 in FIG. 10, with a base 122 for utilization with a lighting fixture or system. As shown in FIGS. 12 and 13 base 122 may be a wedge type base similar to those known in the prior art, like that shown in FIG. 14, however it should be appreciated that base 122 may of LED lighting element 120 may also be any legacy or conventional lamp base including an Edison base (E-base), bi-pin, wedge base, or other lamp bases similar to those used in incandescent, fluorescent, xenon, halogen or other lamps. It is further contemplated that base 122 can take any form necessary for non-conventional or custom bases utilized by any lighting fixture or system. As shown in FIG. 15, LED lighting element 120 may take the form of a Festoon type bulb having bases 132. Essentially lighting element 120 can be integrated with any base so as allow basic and/or opposing parallel LED circuits 10, 50, 110 and the like to connect with and be utilized in any light fixture or system.

As shown in FIGS. 12, 13, and 15 the AC-driven lighting element may further contemplates a lens 124.

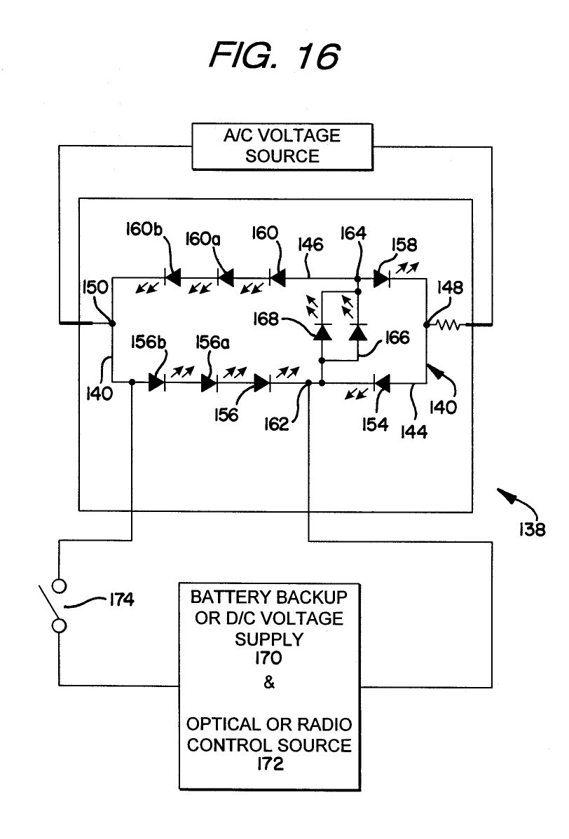

FIG. 16 discloses an AC-driven LED element 138 having a circuit 140 including a first basic circuit 142 having a first branch 144, and a second branch 146 and a DC backup supply 170. Branches 144, 146 connect at first common point 148 and second common point 150. The common points 148, 150 provide input an output for an AC driving current from a driver 152 for the circuit.

The first branch 144 has at least a first LED 154 and a second LED 156, and the second branch 146 having at least a third LED 158 and a fourth LED 160. The first LED 154 is connected to the second LED 156 in opposing series relationship with the inputs of the first and second LEDs 154, 156 defining a first branch junction 162. The third LED 158 is connected to the fourth LED 160 in opposing series with the outputs of the third and fourth LEDs 158, 160 defining a second branch junction 164. As should be appreciated by those of skill in the art and shown in FIG. 16, it is further possible to add additional pairs of LEDs to each branch so long as each additional LED is orientated in an identical manner as any LED located between the same branch junction 162, 164 and common point 148, 150. Such an embodiment is shown, for example, in FIG. 16 wherein additional LEDs 156a, 156b, 160a, and 160b have been added to the first and second branches.

The first and second branches 144, 146 are connected to one another such that the output of the first LED 154 is connected to the input of the third LED 158 at the first common point 148 and the output of the second LED 156 is connected to the input of the fourth LED 160 at the second common point 150. A first cross-connecting circuit branch 166 has a fifth LED 168. The first cross-connecting circuit branch 166 being configured such that the input of the fifth LED 168 is connected to second branch junction 164 and the output is connected to the first branch junction 162.

As will be appreciated by those of skill in the art, the LEDs 154 and 160 will provide light only upon one half of an AC wave, pulse or phase, while LEDs 156 and 158 will provide light only upon the opposite wave, pulse or phase. At lower frequencies, e.g. mains frequencies, if the LEDs are spaced pursuant to another aspect of the invention (disclosed below) at preferably approximately 3.0 mm or less preferably approximately 2.0 mm or less, then the amount of noticeable flicker may not be unacceptable. However, the cross connecting branch 166 and diode 168 will be on (produce light) in both phases of the AC drive and hence mitigate flicker which may be evidenced in its surrounding LEDs 154, 156, 158 and 160.

As shown in FIG. 16, the DC backup supply 170 integrated with the LED light element 138 includes a sensor 172 for controlling the backup supply 170. In alternative embodiments of the invention, DC backup supply 170 and sensor 172 may provided in a light fixture utilizing LED light element 138, or may otherwise be connected to LED light element 138 from some other outside source. As should be appreciated by one having skill in the art, DC backup supply 170 may be connected to or integrated with LED light element 138 in any manner which allows DC backup supply 170 to provide power to LED light element 138 when an AC source is unavailable.

The DC backup supply 170 may be, for example a battery, a capacitor or any other device capable of storing a DC voltage therein. Likewise, sensor 172 can be any known in the art, including but not limited to an optical light sensor or a radio sensor for receiving a signal from a remote control (not pictured). The sensor 172 connects to at least a portion of basic circuit 140 through switch 174. Sensor 172 is configured to close switch 174 when, for example the light level surrounding the light element 138 drops below a predetermined level or upon receipt of a signal from a remote control directing the usage of the DC backup supply. Upon closure of the switch 174, DC backup supply 170 provides power to any LEDs connected with the DC backup supply 170.

As shown in FIG. 16, the DC backup supply 170 can be connected across only a portion of the LEDs, shown as second LEDs 156, 156a, 156b. As should be appreciated by those having skill in the art, though not shown in FIG. 16, DC backup supply is capable of being connected to only one LED, for example LED 160, or across an entire branch of the LED circuit 140, for example across LEDs 156, 156a, 156b, 158, and 168.

By integrating or connecting the DC backup supply 170 with the LED lighting element 138, it should be appreciated by those having skill in the art that maximum efficiency can be realized as the DC backup supply 170 can be chosen such that it substantially matches the known total voltage drop of each of the LEDs the DC backup supply is connected to, shown in FIG. 16 as LEDs 156, 156a, 156b. It should be noted that it is also contemplated that an additional circuit and/or circuit elements may be placed between the DC backup supply and the LED lighting element 138 in order to match the total load voltage with the voltage provided by the DC backup supply.

It is further contemplated that a LED lighting element 138 having a DC backup supply 170 integrated therein may be integrated into a package like that disclosed in any of FIGS. 11, 12, 13, and 15 with a base for integrating the AC LED light element into a lighting fixture or system. As described herein, the AC LED light element 138 may have a conventional lamp base or a non-conventional or custom lamp base.

According to the invention, the various embodiments of the basic LED circuits and larger circuits of serial and parallel arrangements of same are formed by forming the die/and or other circuit elements on a single semiconductor chip or a substrate, or mounted to substrates, and assemblies may be produced, such as creating an AC-driven circuit where all circuits and LEDs are formed on a semiconductor, where the LED are discretely packaged apart from the circuits, and where each basic circuit is formed on a printed circuit board. Preferably according to an aspect of the invention the basic circuits and larger circuits combining them may be formed on a sapphire substrate for thermal management of the numerous LED die.

According to the invention, each basic LED circuit may be formed by wiring individual LED die on a substrate. In cases where such a manner is used for forming LED circuits, the substrate on which the basic circuit is formed is integrated as part of the AC LED lighting element including a base for connection to a lighting fixture or system.

According to the invention, the basic circuits may be monolithically integrated within a single AC-LED chip. In such cases, the LED chip is integrated as part of the AC LED lighting element including a base for connection to a lighting fixture or system.

While in the preceding there has been set forth a preferred embodiment of the invention, it is to be understood that the present invention may be embodied in other specific forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying Claims.

We claim:

1. An AC-driven LED lighting element comprising:
a first basic circuit having LEDs, each LED having an input and an output, and the circuit having at least first and second branches connecting at first and second common points, the common points providing input and output for an AC driving current for the circuit;
the first branch having a first and a second LED, and the second branch having a third and a fourth LED;
the first LED is connected to the second LED in opposing series relationship with the inputs of the first and second LEDs defining a first branch junction;
the third LED is connected to the fourth LED in opposing series with the outputs of the third and fourth LEDs defining a second branch junction,
the first and second branches are connected to one another such that the output of the first LED is connected to the input of the third LED at the first common point and the output of the second LED is connected to the input of the fourth LED at the second common point;
a first cross-connecting circuit branch having at least a fifth LED, the first cross-connecting circuit branch being configured such that the input of the fifth LED is connected to the second branch junction and the output is connected to the first branch junction; and,
a base for connecting the first basic circuit to a lighting fixture or system.

2. The AC-driven LED lighting element according to claim 1 further comprising one or more additional basic circuits substantially the same as the first basic circuit, each additional circuit being conductively connected to the first basic circuit and to one another at the their common points for providing an input and an output for an AC driving current for the circuit.

3. The AC-driven LED lighting element according to claim 2 wherein the additional basic circuits are connected in series.

4. The AC-driven LED lighting element according to claim 2 wherein the additional basic circuits are connected in parallel.

5. The AC-driven LED lighting element according to claim 1 further comprising n additional LEDs, in pairs, wherein the pairs are configured among the first and second branch circuits of each of the respective basic circuits, such that current flows through the respective fifth diode of each basic circuit during both phases of an AC driving source.

6. The AC-driven LED lighting element according to claim 1 further comprising x cross-connecting circuit branches for each basic circuit, each x cross-connecting circuit branch having one or more LEDs configured such that current flows through each of the respective one or more LEDS during both phases of an AC driving source.

7. The AC-driven LED lighting element according to claim 2 wherein the current draw through each of the respective basic circuits during both AC phases is substantially the same.

8. The AC-driven LED lighting element according to claim 1 wherein the number and type of LEDs of the AC-driven LED circuit draw a combined current which is substantially equal to the nominal current capacity of an AC-source.

9. The AC-driven LED lighting element according to claim 1 wherein the number and type of LEDs of the AC-driven LED circuit drops a combined voltage which is substantially equal to the nominal voltage capacity of an AC-source.

10. The AC-driven LED lighting element according to claim 2 wherein the first basic circuit and each additional basic circuit has a voltage drop of 12 V.

11. The AC-driven lighting element of claim 1 wherein the first basic circuit is formed with individual LED die on a substrate.

12. The AC-driven LED lighting element of claim 11 wherein the substrate is integrated within the AC LED lighting element.

13. The AC-driven LED lighting elements of claim 1 wherein the basic circuit is formed on a printed circuit board.

14. The AC-driven LED lighting elements of claim 1 wherein the basic circuit is monolithically integrated within a single AC LED chip.

15. The AC-driven LED lighting element of claim 14 wherein the single AC LED chip is integrated into the AC-driven lighting element.

16. The AC-driven LED lighting elements of claim 1 having a lens.

17. The AC-driven lighting element of claim 1 comprising one or more of a transient voltage suppressor device, a fuse element, and a resistor.

18. The AC-driven lighting elements of claim 1 wherein the base is a conventional lamp base.

19. The AC-driven lighting elements of claim 1 wherein the base is a non-conventional lamp base.

20. A method for constructing an AC LED lighting element, the method comprising the steps of:
forming a first branch by connecting a first LED to a second LED in opposing series relationship orientated such that the outputs of each LED form a first junction;
forming a second branch by connected a third LED to a fourth LED in opposing series relationship orientated such that the inputs of each LED form a second junction; forming a first basic circuit by
connecting the least first and second branches at first and second common points; and,
connecting the first junction and the second with a first cross-connecting circuit branch having at least a fifth LED so that the first, fourth, and fifth LEDs form a closed circuit during one phase of an AC source and the second, third, and fifth LEDs form a closed circuit during a second phase of the AC source; and,
integrating a base with the first basic circuit to facilitate integration with a lighting fixture or system.

21. The method of claim 20 further comprising the step of connecting one or more additional basic circuits substantially identical to the first basic circuit in series and/or parallel to the first basic circuit so that a total forward voltage across all of the basic circuits substantially matches a desired total voltage drop.

22. The method of claim 21 further comprising the step of connecting one or more opposing parallel LED circuits in series and/or parallel to the first basic circuit.

23. The method of claim 22 further comprising the step of dropping substantially identical voltage in both the positive and negative phase of the AC source in the first basic circuit and the one or more additional basic circuits.

24. The method of claim 23 further comprising the step of dropping 12 V in both the positive phase and the negative phase of the AC source across the first basic circuit and the one or more additional basic circuits.

25. The method of claim 20 further comprising the step of integrating a conventional lamp base with the first basic circuit.

26. The method of claim 20 further comprising the step of integrating a non-conventional lamp base with the first basic circuit.

27. The method of claim 20 further comprising the step of adding n LEDs, in pairs, wherein the pairs are configured among the first and second branches of the first basic circuit.

28. The method of claim 20 further comprising the step of adding n LEDs, in pairs, wherein the pairs are configured among the first and second branches of the first basic circuit such that a total forward voltage drop across both the branches substantially matches a desired voltage drop.

29. The method of claim 20 further comprising the step of adding x LEDs in parallel with the cross-connecting circuit branch in the first basic circuit.

30. An AC LED light element comprising:
a first basic circuit having LEDs, each LED having an input and an output, and the circuit having at least first and second branches connecting at first and second common points, the common points providing input and output for an AC driving current for the circuit;
the first branch having at least first and a second LED, and the second branch having at least third and a fourth LED;
the first LED is connected to the second LED in opposing series relationship with the inputs of the first and second LEDs defining a first branch junction;
the third LED is connected to the fourth LED in opposing series with the outputs of the third and fourth LEDs defining a second branch junction,
the first and second branches are connected to one another such that the output of the first LED is connected to the input of the third LED at the first common point and the output of the second LED is connected to the input of the fourth LED at the second common point;
a first cross-connecting circuit branch having at least a fifth LED, the first cross-connecting circuit branch being configured such that the input of the fifth LED is connected to the second branch junction and the output is connected to the first branch junction; and,
a DC backup supply connected to at least one of the first, second, third, fourth, or fifth LEDs.

31. The AC LED light element of claim 30 further comprising an optical light sensor for controlling the DC backup supply.

32. The AC LED light element of claim 30 further comprising a remote control sensor in communication with a remote control for controlling the DC backup supply.

33. The AC LED light element of claim 30 wherein the DC backup is connected to only one of the first, second, third, fourth, or fifth LEDs.

34. The AC LED light element of claim 30 wherein the DC backup supply is connected to either the first or second branch of the basic circuit.

35. The AC LED light element of claim 30 wherein the DC backup supply substantially matches the known total voltage drop of each of the LEDs the DC backup supply is connected to.

36. The AC LED light element of claim 30 wherein the DC backup supply is a battery.

37. The AC LED light element of claim 30 wherein the DC backup supply is a capacitor.

38. The AC LED light element of claim 30 further comprising a base for integrating the AC LED light element into a lighting fixture or system.

39. The AC LED light element of claim 38 wherein the base is a conventional lamp base.

40. The AC LED light element of claim 38 wherein the base is a non-conventional lamp base.

41. The AC LED light element of claim 1 wherein the base includes a dielectric portion having at least two separate conductive points electrically connected to the basic circuit on a first side and configured on a second side for connecting the basic circuit with a lighting fixture or system.
